(19) United States
(12) Patent Application Publication
(10) Pub. No.: US 2006/0158307 A1
(43) Pub. Date: Jul. 20, 2006

(54) System and method for face recognition

(75) Inventors: Jong-ha Lee, Hwaseong-si (KR); Jung-bae Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/330,166

(22) Filed: Jan. 12, 2006

(30) Foreign Application Priority Data
Jan. 13, 2005 (KR) 10-2005-0003291

(51) Int. Cl. G06K 9/00

(52) U.S. Cl. 340/5.53; 382/115; 340/5.83

(57) ABSTRACT

A method of face recognition, and a system to perform the method, the method including performing face identification by comparing a face image received from a user with stored face information; performing face verification by comparing the received face image and the stored face information which corresponds to personal information received from the user; and updating the stored face information according to the received face image in response to authenticating the user through a successful face verification.

### CROSS-REFERENCE TO RELATED APPLICATIONS

This application claims the benefit of Korean Patent Application No. 10-2005-0003291, filed on Jan. 13, 2005, in the Korean Intellectual Property Office, the disclosure of which is incorporated herein by reference.

### BACKGROUND OF THE INVENTION

1. Field of the Invention

The present invention is directed to face recognition. In particular, it relates to a system and a method to achieve more effective face recognition by updating information for face identification through face verification.

2. Description of the Related Art

Biometrics technology, which until now has been seen primarily in science fiction and spy movies, is slowly becoming reality. Biometrics technology, which has been used in particular fields to authenticate individuals, has rapidly diffused into other areas due to a drop in the price of the technology, and an information-oriented infrastructure has been built rapidly due to the development of the technology itself and other related technology.

Biometrics is a technology used to identify an individual by using features of his/her body or behavior. In a narrow sense, it is a technology that allows the features of a person's body or behavior to be recognized by a machine, and identifying an individual from these features. Biometrics technology uses the features of a person's body, including, for example, fingerprints, the face, the iris or retina of an eye, and veins. Conventional technology typically uses a signature and voice. Individual identifying technology based on analysis of the shapes of ears or how a person walks (his or her gait) is also being actively studied. In addition, genetic engineering has developed remarkably, and a method of verifying a person using DNA has been developed, and has been used in some commercial fields. Such biometrics technology has also been used in criminal investigations. Human beings have distinct fingerprints, which can be used as a means for distinguishing people; it is the most developed biometrics field in terms of mechanization and computerization.

Recently, biometrics technology is attracting keen attention, and the technology is surfacing as a field of interest for two particular reasons. First, it is regarded as an important technology for security and management. That is, biometrics technology is required in applied fields including entrance control, attendance management, equipment management, computer security, remote education, electronic commercial transactions, and information security. In particular, since most important information is processed by a computer in the information industry, information exchange can be done efficiently via the Internet. As the scope of electronic commercial transactions enlarges, the need for reliable authentication grows.

Secondly, the convenience of biometrics technology is one of its most important merits, as compared to the conventional individual authentication method using a password, ID, and key. That is, in the case of an individual authentication using biometrics technology, a person can be authenticated easily and reliably using the person's fingerprints or voice, instead of using an ID card, a magnetic card, a smart card, or memorizing a password. Further, a technology by which machines can automatically operate to meet a user's demands in response to the machines recognizing the user via biometrics can be realized. For example, as soon as a user sits in the driver's seat, the rearview mirror or the seat is adjusted automatically so that the user is comfortable, which is accomplished via face recognition. In case of an unregistered user, a technology which disables the engine can be realized. In this way, biometrics technology can provide security and convenience to people's lives, and can produce positive economic effects.

A biometrics process using facial recognition will be described. First, a user must register user information in a biometrics system. For registration, the user has to input an image of his/her face via a device such as a camera for facial recognition. The input bio-information is raw data, and if this information is processed by a signal processing algorithm such as an image processor, feature data representing an individual's face can be obtained. This feature data functions as a standard template, and if the standard template is stored in a storage medium, the user's information registration process is completed. The type of the storage medium may be different according to the system used. In the case of an embedded system such as a biometrics door lock, the standard template may be stored in a flash memory of a common system, and in the case of separate PC security, it may be stored in the hard disk of the PC. The standard template may be stored in a central database for the purpose of authentication in a network environment. Depending on the circumstances, the standard template may be stored in a smartcard.

After user registration is completed, the user provides facial bio-information to the biometrics system when he/she would like to use the biometrics system. The biometrics system processes this information to acquire feature data. Thereafter, the system obtains a similarity or probability match by comparing the acquired feature data with the standard template obtained in the course of registration. Subsequently, the obtained similarity or probability match is compared with a preset threshold value, and it is determined whether the user is authentic.

Concepts typically known as “face verification” and “face identification” apply here.

“Face verification” is conducted by 1:1 matching. For the face verification, a user's ID and his/her bio-information, that is, face information, are provided together to a biometrics system as input data, and the biometrics system compares feature data derived from the input face information with the standard template corresponding to the input ID. “Face identification” is conducted by 1:N matching. For the face identification, only the bio-information, that is, only the face information, is provided to the biometrics system as input data, and a person matching the face information is identified using information of a registered person corresponding to a standard template having the highest similarity, among the standard templates stored in the biometrics system.

In the face verification system, when the standard template (which the person has already registered) matches feature data derived from the face information that he/she is now inputting, the user receives from the system a permission to access it. In the face identification system, a database containing feature data of several persons is searched, and the data most similar to that of a specific person input is found, and the identity of the person is ascertained from this search result.

The face verification system is applied to diverse commercial fields which require passwords for access control, payment certification, and the like. For example, the system can be extensively used in a door lock device using a user input ID and face information. The face identification system has been widely applied as a search system to find criminals using the face identification technology, and may be utilized by cameras mounted in places where crowds gather.

As compared with the conventional authentication system based on only an ID and password, the biometrics system is remarkably different because a perfect positive response (100% Yes) and a perfect negative response (100% No) are not possible. Using a password, if the input character strings are identical to the password, a 100% Yes response is produced, and if the strings are not identical, a 100% No response is produced. However, in the biometrics system, the inputted bio-information may vary slightly every time depending upon, for example, the shape and/or an angle of input and its working illumination condition, and the probability match between the standard template and the bio-information changes accordingly. Therefore, even though the user is the same person, that is, a registered user, the user may be rejected. Further, a different person, that is, an unregistered user, may be erroneously granted permission to access the system from the biometrics system. There is a False Rejection Ratio (FRR) and a False Acceptance Rate (FAR) that numerically represent the probability of both cases. FRR is also called a ratio of wrongly rejecting the right person, and FAR is also called a ratio of wrongly accepting an unauthorized person.

Like a Support Vector Machine (SVM) algorithm, the face verification technology mainly employs a learning algorithm based on a classifier, which is mainly used in the security apparatuses because it has generally higher recognition performance, and lower FRR and FAR, as compared with the face identification technology. But it is inconvenient since individual information such as an ID and a password is inputted. In addition, it takes a long time to conduct 1:N comparisons using the above-mentioned face verification technology. For example, assuming that it takes about 30 to 50 ms to perform one face verification job using a 2.4 GHz Pentium 4 computer, it would take about 30 to 50 seconds to verify 1,000 registered persons.

In the face identification technology, feature data for a face is stored by a descriptor having a size of less than k bytes using a feature extractor based on Principal Component Analysis (PCA) or a Gaber wavelet, and face recognition is performed using the stored feature data. The face identification technology can quickly perform the face recognition, and needs no input of personal information such as an ID and password, thereby making it convenient to use. But, since the face identification technology has a generally higher FRR and FAR as compared with the face verification technology, it cannot be advantageously applied to security apparatuses.

Accordingly, there is a need for a new face recognition method having a higher security level, which does not require inputting individual information separately, and which adopts only the advantages of the face verification and face identification technologies.

### SUMMARY OF THE INVENTION

The present invention has been conceived in order to improve the problems described above and/or other problems. It is an aspect of the present invention to provide a method of more effective face recognition by updating information for face identification through face verification.

Additional aspects and/or advantages of the invention will be set forth in part in the description which follows and, in part, will be apparent from the description, or may be learned by practice of the invention.

According to an aspect of the present invention, there is provided a face recognition system comprising an image input unit to receive a face image from a user; a user interface to receive personal information selectively input by the user; a face information storage unit to store personal information regarding a plurality of individuals, and face information corresponding to the personal information; a face identification unit to conduct face recognition by comparing the face image received from the image input unit with the face information stored in the face information unit; and a face verification unit to perform face verification using the face information that corresponds to the user's personal information, and that is stored in the face information storage unit, and the face image received from the image input unit, and to update the face information already stored in the face information storage unit according to the face image received from the image input unit.

The face identification unit may conduct the face recognition within a predetermined time limit.

The face verification unit may comprise an ID determining module to derive the face information corresponding to the user's personal information from the face information storage unit in response to receiving the user's personal information from the user interface; a similarity determining module to determine a similarity between the face image received from the image input unit and the face information derived by the ID determining module; and a face registration determining module to update the face information already stored in the face information storage unit according to the face image received from the image input unit in response to the determined similarity being in a predetermined threshold range.

The face identification unit may comprise a feature deriving module to derive features from the face image received from the image input unit, and to derive feature vectors of faces stored in the face information storage unit and a similarity determining module to determine respective similarities between the face image and the faces stored in the face information storage unit, using the derived feature vectors, select a highest similarity value among the determined similarities, and perform face recognition of a face stored in the face information storage unit which corresponds to the highest similarity value.

The face recognition system may further comprise a door driving unit to open/close a door in response to receiving a predetermined control signal from the face recognition unit indicating a successful authentication of the user.

According to another aspect of the present invention, there is provided a face recognition method comprising receiving a face image of a user from an image capturing device; receiving personal information selectively input by the user; comparing the received face image with information regarding a plurality of registered faces, and conducting face identification; and comparing information regarding a registered face corresponding to the user's personal information with the received face image, and conducting face verification; wherein the information regarding the corresponding registered face is updated according to the received face image, to be used for a subsequent face identification, in response to an authentication of the user being successful through the face verification.

According to another aspect of the present invention, there is provided a face recognition system comprising a face identification unit to conduct face recognition by comparing a face image received from a user with stored face information; and a face verification unit to perform face verification by comparing the received face image and the stored face information which corresponds to personal information received from the user; wherein the stored face information is updated according to the received face image in response to authenticating the user through a successful face verification.

The face verification may not be performed in subsequent face recognition operations for a predetermined time after the authentication of the user.

According to another aspect of the present invention, there is provided a method of face recognition, the method comprising: performing face identification by comparing a face image received from a user with stored face information; performing face verification by comparing the received face image and the stored face information which corresponds to personal information received from the user; and updating the stored face information according to the received face image in response to authenticating the user through a successful face verification.

According to another aspect of the present invention, there is provided a face recognition system comprising a face verification unit to receive a face image and personal information from a user and perform face verification by comparing the received face image and stored face information which corresponds to the received personal information; wherein the stored face information is updated according to the received face image in response to authenticating the user through a successful face verification.

The face recognition system may further comprise a face identification unit to conduct face recognition by comparing the received face image with the stored face information.

The face identification unit may conduct the face recognition without the face verification unit performing the face verification for a predetermined time after the updating of the stored face information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart illustrating a face recognition method according to an embodiment of the present invention;

FIG. 2 is a flow chart illustrating a face verification method according to an embodiment of the present invention;

FIG. 3 is a flow chart illustrating a face identification method according to an embodiment of the present invention;

FIG. 4 is a block diagram illustrating a face recognition system according to an embodiment of the present invention;

FIG. 5 is a block diagram illustrating a face verification unit according to an embodiment of the present invention;

FIG. 6 is a block diagram illustrating a face identification unit according to an embodiment of the present invention; and

FIG. 7 is a block diagram illustrating a face recognition system according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The present invention may, however, be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims.

The present invention will be described with reference to accompanying drawings composed of block diagrams or flow charts to disclose a face recognition system and method according to discussed embodiments thereof.

At this time, it will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer that can direct a computer or other programmable data processing apparatus to function in a particular manner, such that the instructions stored in the disclosure of the present invention produce an article of manufacture including instruction means that implement the function specified in the flowchart block or blocks.

The computer program instructions may also be loaded onto a computer or other programmable data processing apparatus to cause a series of operations to be performed on the computer or other programmable data processing apparatus to produce a computer implemented process such that the instructions that are executed on the computer or other programmable data processing apparatus provide operations which implement the functions specified in the flowchart block or blocks.

Each block of the flowchart illustrations may represent a module, segment, or portion of code, which comprises one or more executable instructions which implement the specified logical function(s). It should also be noted that in some alternative implementations, the functions noted in the blocks may be in fact be executed substantially concurrently, or the blocks may be executed in reverse order, depending upon the functionality involved.

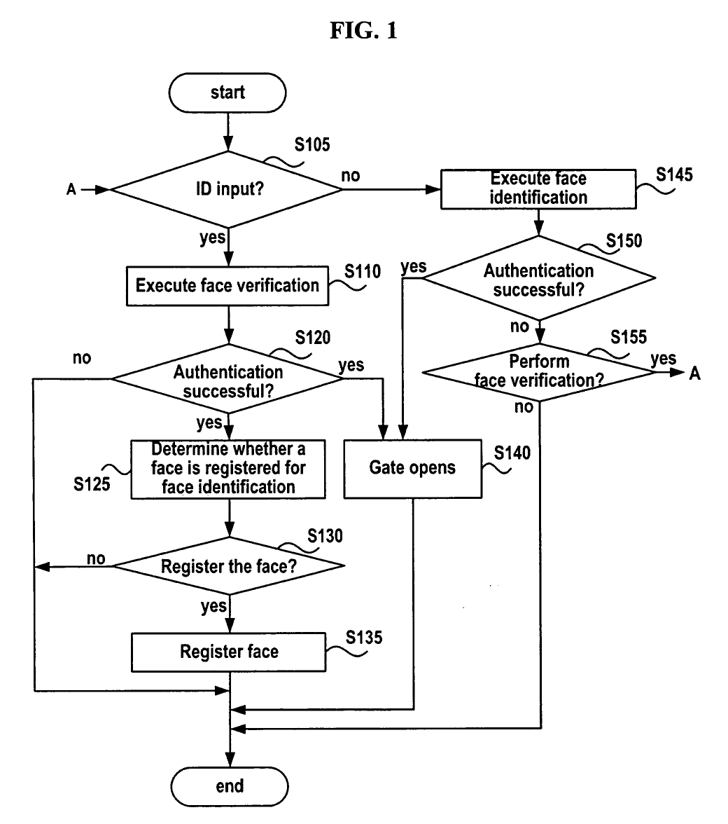

FIG. 1 is a flow chart illustrating a face recognition method according to an embodiment of the present invention.

It is assumed that in order to pass through a gate a user passes through an entrance control system using face recognition. First, a user may position his/her face in front of an image capturing device such as a camera arranged in the entrance control system, or (s)he may input his/her personal information, such as an ID, through an input arranged at the entrance control system. The positioning of the user's face without inputting the ID is performed in the case of a face identification, and the positioning of the user's face while inputting the ID is performed in the case of a face verification. Preferably, though not necessarily, the entrance control system allows the user to select face verification or face identification, and corresponding operations are executed. Also, a time limit for the face identification may be set; that is, the user may be allowed to enter into the gate only within the set time limit. Accordingly, when the time limit expires, the database (DB) used in the face identification is updated through a face verification, and the face identification is executed according to the updated DB. The time limit may be pre-set in the entrance control system to which this embodiment of the present invention is applied, or it may be arbitrarily set by a user. Even when the time limit has not expired, the user may update the DB used in the face identification in response to the user arbitrarily executing a face verification.

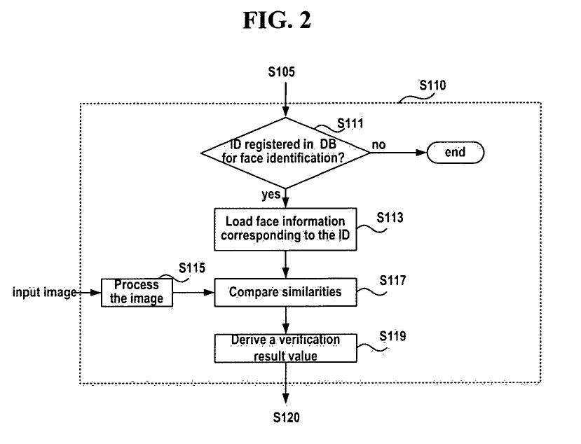

The user may input his/her ID in operation S105 of FIG. 1 in response to the user recognizing that the time limit for a face identification has expired, or when he/she retries a face verification due to a problem having occurred with regard to admission through the face identification. Once the ID is input, the entrance control system compares stored face information corresponding to the input ID with the input face image of the user to thereby execute the face verification in operation S110. The face verification method will be explained later in this description by referring to FIG. 2. After the face verification, it is determined whether to authenticate the user according to the result obtained by the face verification in operation S120. If the user's authentication is successful, the gate is opened in operation S140, but if the user's authentication is not successful, the gate is not opened. Also, if the user's authentication is successful in operation S120, the entrance control system determines, according to a special judgment criterion, whether the user's face image acquired by the face verification process is to be updated and registered in the DB used in the face identification in operations S125 and S130. If it is determined that the face image is to be registered as a new image, the entrance control system registers the face image of the user as an image inputted for the face identification in operation S135.

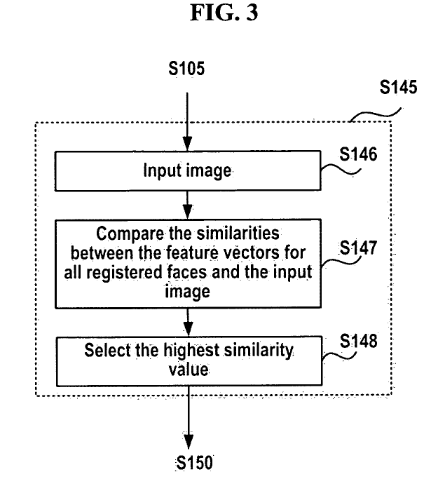

In a case in which the user does not know how much time may be taken before the time limit expires, or when he/she wants to gain admission through the face identification process, the user may choose to not input his/her ID in operation S105 of FIG. 1, so that the entrance control system directly executes the face identification in operation S145. The face identification method will be explained in detail later in this description by referring to FIG. 3.

It is then determined whether to authenticate the user according to the result obtained by the face identification. If the user's authentication is successful in operation S150, the gate is opened, and operation of the entrance control system is finished in operation S140. At this time, it is possible to improve the security level of the entrance control system by setting a threshold value to be higher than before.

If the user's authentication is not successful in operation S150, the entrance control system automatically provides the user with a response, such as a voice message or a specific sound, to notify the user that the authentication did not succeed. Then, the entrance control system asks the user whether it should continue and execute the face verification in operation S155. If the user desires to execute the face verification, operation S105 will be performed. The face verification serves to complement the recognition performance of the face identification.

According to another embodiment of the present invention, in the case in which the user's authentication succeeds in operation S150, the gate may not be immediately opened. Instead, the entrance control system proceeds to operation S110, so as to conduct the face verification using an ID corresponding to the face already successfully authenticated in operation S150.

In another embodiment of the present invention, in the case in which the authentication is successful in operation S150, the gate is immediately opened, and at the same time, the entrance control system proceeds to operation S125 so as to determine whether to update and register the user's face image that was successfully authenticated as an image to be used in face identification.

The operations illustrated in FIG. 1 may be applied in ordinary business offices by setting the time limit for a face identification on a daily basis. For example, when the first user appears in the office and inputs his/her ID, the face verification process may be executed. Then, if the user's authentication is succeeded by the face verification, the entrance control system registers the user's face image as the day's image for face identification, and thereafter conducts the face identification rather than the face verification. Generally, since one's hair style, make-up, and dress typically change from day to day, and the performance of the entrance control system may be improved by adding dress, hair style, and other similar attributes to the face features, the system becomes robust against such changes in accessories and make-up.

FIG. 2 is a flow chart illustrating a face verification method according to an embodiment of the present invention. FIG. 2 illustrates operation S110 of FIG. 1 in more detail.

The entrance control system determines whether the input ID is registered in the DB used in face identification in operation S111, and terminates the face authentication process if the input ID is not registered. If the ID is determined to be registered in the DB in operation S111, the entrance control system loads the face information corresponding to the relevant ID in operation S113.

The entrance control system receives the face image input by a user, processes the input image in operation S115, and compares the loaded face information and the processed image in operation S117. This comparison may use the conventional face verification technology.

In response to the verification result value being derived by the similarity comparison in operation S119, the derived result value and the threshold value required for authentication are compared in operation S120 of FIG. 1 in order to determine whether the authentication was successful.

FIG. 3 is a flow chart illustrating a face identification method according to an embodiment of the present invention. FIG. 3 illustrates operation S145 of FIG. 1 in more detail. In operation S105 of FIG. 1, if the user does not input his/her ID, the entrance control system receives a face image of the user in operation S146, and compares the respective similarities between the input image and the feature vectors of all the faces registered in the DB to be used in the face identification in operation S147. As a result of the comparison, the entrance control system selects the highest similarity value in operation S148, and determines whether the authentication is successful in operation S150 of FIG. 1 by comparing the selected similarity value with the threshold required for authentication. This process may use the conventional face identification algorithm.

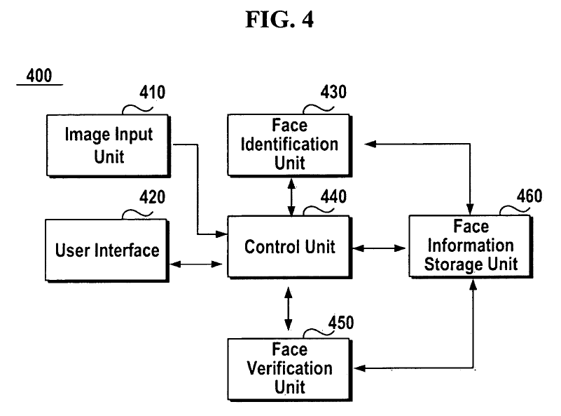

FIG. 4 is a block diagram illustrating a face recognition system according to an embodiment of the present invention. The face recognition system 400 comprises a user interface 420, an image input unit 410, a control unit 440, a face identification unit 430, a face verification unit 450, and a face information storage unit 460.

Throughout this specification, the term “unit” may refer to a hardware element such as an FPGA (Field Programmable Gate array), or an ASIC (Application Specific Integrated Circuit), that performs a predetermined function. A “unit” may be arranged to reside in an addressable storage medium, or may be formed to execute one or more processes. Therefore, “unit” may include, for example, elements such as the software elements, object-oriented software elements, class elements and task elements, processors, functions, attributes, procedures, subroutines, segments of program code, drivers, firmware, microcode, circuits, data, databases, data structures, tables, arrays, and parameters. The elements and the functions of a “unit” may be combined into s smaller number of elements, or separated into more elements.

The image input unit 410 receives a face image input by a user in order to conduct a face identification or a face verification, and may execute an image processing operation so that the face image can be processed by the control unit 440. The user interface 420 provides an input by which the user can choose to execute the face identification or the face verification, and the user interface 420 transmits this selection to the control unit 440. The user interface 420 also provides an input to enable the user to input his/her ID in response to the user's face being verified. The user interface 420 further includes an output, such as a display, to notify the user of any other messages or information necessary for the face authentication. In addition, the user interface 420 may include an output to automatically produce a voice message or a specific sound in response to the face verification or face authentication not being successful.

The control unit 440 receives the relevant information input from the image input unit 410 and the user interface 420, respectively. In response to the face verification being executed using the input information, the face verification unit 450 operates, and in response to the face identification being executed, the face identification unit 430 operates. In addition, the control unit 440 controls the sequence of the processes illustrated in FIG. 1.

The face verification unit 450 or the face identification unit 430 performs the operations illustrated in FIG. 2 or FIG. 3, respectively. The face information storage unit 460 stores a user ID already registered, and face information corresponding to the ID. This information is used during the operation of the face verification unit 450 or the face identification unit 430.

The control unit 440 outputs a signal for admission (not shown in FIG. 4) in response to the face recognition system 400 determining that a user may be granted admission, and the gate then opens.

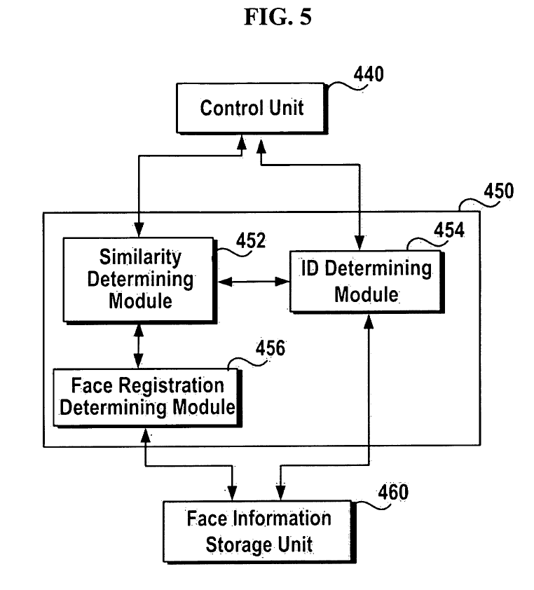

FIG. 5 is a block diagram illustrating a face verification unit 450 according to an embodiment of the present invention, in which the operations illustrated in FIG. 2 are conducted.

The face verification unit 450 includes a similarity determining module 452, an ID determining module 454, and a face registration determining module 456. Here, the term “module” corresponds to the term “unit” described above.

The ID determining module 454 determines whether the user ID inputted from the user interface 420 is registered in the face information storage unit 460. If the user ID is registered in the face information storage unit 460, the face information corresponding to the user ID is loaded and is transmitted to the similarity determining module 452.

The similarity determining module 452 compares the information transmitted from the ID determining module 454 and the face information input from the user, and transmits the result of the comparison to the face registration determining module 456. Then, the face registration determining module 456 registers the face information of the image received from the image input unit 410 in the face information storage unit 460 in response to the result value being in a predetermined threshold range, and transmits the result to the control unit 440.

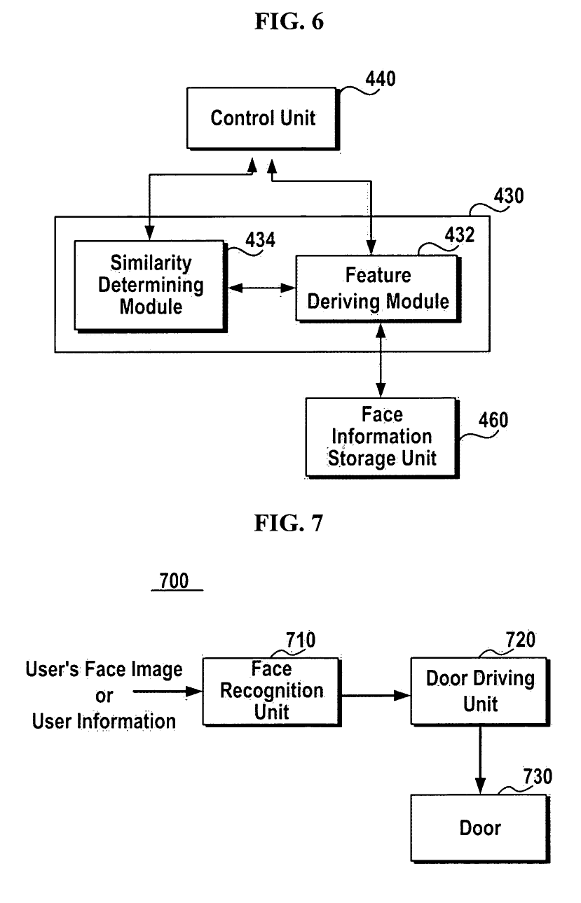

FIG. 6 is a block diagram illustrating a face identification unit 430 according to an embodiment of the present invention, which conducts the operations of FIG. 2. The face identification unit 430 includes a similarity determining module 434 and a feature deriving module 432. Here, the term “module” corresponds to the term “unit” described above.

The feature deriving module 432 receives the user's face image from the control unit 440, derives features from the image, and transmits the information to the similarity determining module 434. The feature deriving module 432 derives feature vectors for all the faces registered in the face information storage unit 460, and transmits them to the similarity determining module 434.

The similarity determining module 434 determines similarities between the user's face image and the respective faces registered in the face information storage unit 460 according to the information transmitted from the feature deriving module 432, selects the highest similarity value from the determined similarities, and transmits the value to the control unit 440.

As described above, the face identification method according to the present invention may be applied to an entrance control device, which is illustrated in FIG. 7. Here, the face recognition system 700 includes a face recognition unit 710, a door driving unit 720, and a door 730.

The face recognition unit 710 receives the user's face image or user information input externally from the face recognition system 700. The inner structure of the face recognition unit 710 may have the same structure as those shown in FIGS. 4 to 6. In response to the face recognition unit 710 recognizing the user and determining to admit the user, the control unit, the face verification unit, or the face identification unit within the face recognition unit 710 (all of which are not shown) drives the door driving unit 720, and opens or closes the door 730 according to a control signal transmitted from the face recognition unit 710. The door driving unit 720 may include a mechanical or electronic configuration used to open/close the door 730. Here, the control unit, the face verification unit, and the face identification unit function in the same manner as the control unit 440, the face verification unit 450, and the face identification unit 460 of FIG. 4.

According to an embodiment of the present invention, face verification is conducted only when it is first used within a time limit for face identification, and face identification is thereafter conducted until the time limit expires, thereby creating an efficient system. In addition, the present invention is effective in enhancing the security level of face identification and face recognition.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A face recognition system comprising:
an image input unit to receive a face image from a user;
a user interface to receive personal information selectively input by the user;
a face information storage unit to store personal information regarding a plurality of individuals, and face information corresponding to the personal information;
a face identification unit to conduct face recognition by comparing the face image received from the image input unit with the face information stored in the face information unit; and
a face verification unit to perform face verification using the face information that corresponds to the user's personal information, and that is stored in the face information storage unit, and the face image received from the image input unit, and to update the face information already stored in the face information storage unit according to the face image received from the image input unit.

2. The system of claim 1, wherein the face identification unit conducts the face recognition within a predetermined time limit.

3. The system of claim 2, wherein the face verification unit comprises:
an ID determining module to derive the face information corresponding to the user's personal information from the face information storage unit in response to receiving the user's personal information from the user interface;
a similarity determining module to determine a similarity between the face image received from the image input unit and the face information derived by the ID determining module; and
a face registration determining module to update the face information already stored in the face information storage unit according to the face image received from the image input unit in response to the determined similarity being in a predetermined threshold range.

4. The system of claim 2, wherein the face identification unit comprises:
a feature deriving module to derive features from the face image received from the image input unit, and to derive feature vectors of faces stored in the face information storage unit and
a similarity determining module to determine respective similarities between the face image and the faces stored in the face information storage unit, using the derived feature vectors, select a highest similarity value among the determined similarities, and perform face recognition of a face stored in the face information storage unit which corresponds to the highest similarity value.

5. The system of claim 1, wherein the face verification unit comprises:
an ID determining module to derive the face information corresponding to the user's personal information from the face information storage unit in response to receiving the user's personal information from the user interface;
a similarity determining module to determine a similarity between the face image received from the image input unit and the face information derived by the ID determining module; and
a face registration determining module to update the face information already stored in the face information storage unit according to the face image received from the image input unit in response to the determined similarity being in a predetermined threshold range.

6. The system of claim 1, wherein the face identification unit comprises:
a feature deriving module to derive features from the face image received from the image input unit, and to derive feature vectors of faces stored in the face information storage unit and
a similarity determining module to determine respective similarities between the face image and the faces stored in the face information storage unit, using the derived feature vectors, select a highest similarity value among the determined similarities, and perform face recognition of a face stored in the face information storage unit which corresponds to the highest similarity value.

7. A face recognition method comprising:
receiving a face image of a user from an image capturing device;
receiving personal information selectively input by the user;
comparing the received face image with information regarding a plurality of registered faces, and conducting face identification; and
comparing information regarding a registered face corresponding to the user's personal information with the received face image, and conducting face verification;
wherein the information regarding the corresponding registered face is updated according to the received face image, to be used for a subsequent face identification, in response to an authentication of the user being successful through the face verification.

8. The method of claim 7, wherein the face identification is conducted within a predetermined time.

9. The method of claim 8, wherein the face verification comprises:
deriving the face information corresponding to the user's personal information;
determining a similarity between the received face image and the derived face information; and
determining whether the determined similarity is in a predetermined threshold range for user verification.

10. The method of claim 8, wherein the face identification comprises:
deriving features from the received face image;
deriving feature vectors of the registered faces;
determining respective similarities between the features of the received face image and the feature vectors of the registered faces; and
selecting a highest similarity value among the determined similarities, and performing the face identification of a registered face corresponding to the highest similarity value.

11. The method of claim 7, wherein the face verification comprises:
deriving the face information corresponding to the user's personal information;
determining a similarity between the received face image and the derived face information; and
determining whether the determined similarity is in a predetermined threshold range for user verification.

12. The method of claim 7, wherein the face identification comprises:
deriving features from the received face image;
deriving feature vectors of the registered faces;
determining respective similarities between the features of the received face image and the feature vectors of the registered faces; and
selecting a highest similarity value among the determined similarities, and performing the face identification of a registered face corresponding to the highest similarity value.

13. A face recognition system comprising:
a face recognition unit comprising:
an image input unit to receive a face image from a user,
a user interface to receive personal information selectively input by the user,
a face information storage unit to store personal information regarding a plurality of individuals, and face information corresponding to the personal information,
a face identification unit to conduct face recognition by comparing the face image received from the image input unit with the face information stored in the face information unit, and
a face verification unit to perform face verification using the face information that corresponds to the user's personal information, and that is stored in the face information storage unit, and the face image received from the image input unit, and to update the face information already stored in the face information storage unit according to the face image received from the image input unit; and
a door driving unit to open/close a door in response to receiving a predetermined control signal from the face recognition unit indicating a successful authentication of the user.

14. The system of claim 13, wherein the face identification unit conducts the face recognition within a predetermined time limit.

15. The system of claim 14, wherein the face verification unit comprises:
an ID determining module to derive the face information corresponding to the user's personal information from the face information storage unit in response to receiving the user's personal information from the user interface;
a similarity determining module for to determine a similarity between the face image received from the image input unit and the face information derived by the ID determining module,
a face registration determining module to update the face information already stored in the face information storage unit according to the face image received from the image input unit in response to the determined similarity being in a predetermined threshold range.

16. The system of claim 14, wherein the face identification unit comprises:
a feature deriving module to derive features from the face image received from the image input unit, and to derive feature vectors of faces stored in the face information storage unit;
a similarity determining module to determine respective similarities between the face image and the faces stored in the face information storage unit using the derived feature vectors, select a highest similarity value of the determined similarities, and perform face recognition of a face stored in the face information storage unit which corresponds to the highest similarity value.

17. The system of claim 13, wherein the face verification unit comprises:
an ID determining module to derive the face information corresponding to the user's personal information from the face information storage unit in response to receiving the user's personal information from the user interface;
a similarity determining module for to determine a similarity between the face image received from the image input unit and the face information derived by the ID determining module,
a face registration determining module to update the face information already stored in the face information storage unit according to the face image received from the image input unit in response to the determined similarity being in a predetermined threshold range.

18. The system of claim 13, wherein the face identification unit comprises:
a feature deriving module to derive features from the face image received from the image input unit, and to derive feature vectors of faces stored in the face information storage unit;
a similarity determining module to determine respective similarities between the face image and the faces stored in the face information storage unit using the derived feature vectors, select a highest similarity value of the determined similarities, and perform face recognition of a face stored in the face information storage unit which corresponds to the highest similarity value.

19. At least one computer readable medium storing instructions that control at least one processor to perform a method of face recognition, the method comprising:
receiving a face image of a user from an image capturing device;
receiving personal information selectively input by the user;
comparing the received face image with information regarding a plurality of registered faces, and conducting face identification; and
comparing information regarding a registered face corresponding to the user's personal information with the received face image, and conducting face verification;
wherein the information regarding the corresponding registered face is updated according to the received face image, to be used for a subsequent face identification, in response to an authentication of the user being successful through the face verification.

20. A face recognition system comprising:
a face identification unit to conduct face recognition by comparing a face image received from a user with stored face information; and
a face verification unit to perform face verification by comparing the received face image and the stored face information which corresponds to personal information received from the user;
wherein the stored face information is updated according to the received face image in response to authenticating the user through a successful face verification.

21. The system of claim 20, wherein the face verification is not performed in subsequent face recognition operations for a predetermined time after the authentication of the user.

22. A method of face recognition, the method comprising:
performing face identification by comparing a face image received from a user with stored face information;
performing face verification by comparing the received face image and the stored face information which corresponds to personal information received from the user; and
updating the stored face information according to the received face image in response to authenticating the user through a successful face verification.

23. The method of claim 22, wherein the face verification is not performed in subsequent face recognition operations for a predetermined time after the authentication of the user.

24. A face recognition system comprising:
a face verification unit to receive a face image and personal information from a user and perform face verification by comparing the received face image and stored face information which corresponds to the received personal information;
wherein the stored face information is updated according to the received face image in response to authenticating the user through a successful face verification.

25. The system of claim 24, further comprising a face identification unit to conduct face recognition by comparing the received face image with the stored face information.

26. The system of claim 25, wherein face identification unit conducts the face recognition without the face verification unit performing the face verification for a predetermined time after the updating of the stored face information.
